(19) United States
(12) Patent Application Publication
(10) Pub. No.: US 2014/0100974 A1
(43) Pub. Date: Apr. 10, 2014

(54) TELEPHONE NUMBER PAYMENT SYSTEM

(71) Applicant: ELECTRONIC TRANSACTION SYSTEMS CORP, Sterling, VA (US)

(72) Inventor: Edward Vaughan, Leesburg, VA (US)

(73) Assignee: ELECTRONIC TRANSACTION SYSTEMS CORPORATION, Sterling, VA (US)

(21) Appl. No.: 13/645,060

(22) Filed: Oct. 4, 2012

(51) Int. Cl. G06Q 20/22

(52) U.S. Cl. CPC G06Q 20/227
USPC 705/18

(57) ABSTRACT

An automated method for enabling a customer to make a payment for goods or services using one of several possible payment choices selectable by the customer by entering the customer's mobile telephone number and a personal identification number (PIN) at a point of payment terminal and then selecting one of several possible previously entered credit card numbers or payment mechanisms. Once the payment option is selected, the point of sale terminal conducts the transaction with the selected payment option.

### BACKGROUND

The present invention relates generally to computerized methods and systems for paying for goods and services, and more particularly to a computerized method and system for paying for goods and services using credit.

Myriads of payment systems exist that enable customers to pay with credit cards or even with cash cards. Some systems exist that enable customers to pay with their mobile phones yet these remain unnecessarily complicated.

The present invention is therefore directed to the problem of developing a computerized method and apparatus for simplifying payments made by customers at the point of sale without increasing the risk to the customers due to fraud.

### SUMMARY OF THE INVENTION

The present invention solves these and other problems by providing an automated method for enabling a customer to make a payment for goods or services using one of several possible payment choices selectable by the customer by entering the customer's mobile telephone number and a personal identification number (PIN) at a point of payment terminal and then selecting one of several possible previously entered credit card numbers or payment mechanisms. Once the payment option is selected, the point of sale terminal conducts the transaction with the selected payment option.

### BRIEF DESCRIPTION OF THE DRAWINGS

FIGS. 1-7 depict a transaction flow of a point of payment (POP) terminal operating according to one aspect of the present invention.

FIG. 8 depicts an exemplary embodiment of a payment processing system according to one aspect of the present invention.

FIG. 9 depicts an exemplary embodiment of a method for enabling a user to pay with a telephone number according to another aspect of the present invention.

### DETAILED DESCRIPTION

The present invention comprises an exciting new pay-by-phone solution that will save merchants money while minimizing the security liabilities of the merchant. Merchants are always solicited by individuals reselling merchant services, promising to save them money, only to find that is rarely the case, the reason being that the margins above Interchange are so minimal that processors rarely have the opportunity to offer any significant savings.

The present invention provides the first solution that will not only offer tremendous savings by bypassing Interchange, but can actually make money for the participating merchants. The present invention does not require a phone upgrade yet comprises the most secure Pay-by-Phonetechnology developed to date. The present invention does not require one to carry a wallet or a phone, thus there is no wallet to lose or to be stolen and no chip on the phone to be compromised. Losing one's phone does not give anyone access to one's account. The Phone/pin combination remains only known to the user. Users can pay merchants and other individuals directly. Users can setup and manage recurring bills. A user's entire account can be managed online through a portal provided by the present invention. Merchants can accept mobile payments from consumers as a payment method and merely pay a flat discount rate of 0.40% with no per item charge obtaining a reduction of card discount fees by 70%. These numbers are subject to change based on market factors though.

One exemplary embodiment of the present invention comprises a process in which an individual can pay for goods and services without possessing that individual's magnetic card at the time of purchase. The process includes choosing an alternate payment option when prompted and entering in the individual's unique phone number as well as a user defined Personal Identification Number (PIN) as a method of identification. Furthermore, the system verifies the authenticity of the individual and subsequently takes a credit card or other payment mechanism predetermined by the individual and uses the designated payment mechanism for the purchase of goods and services.

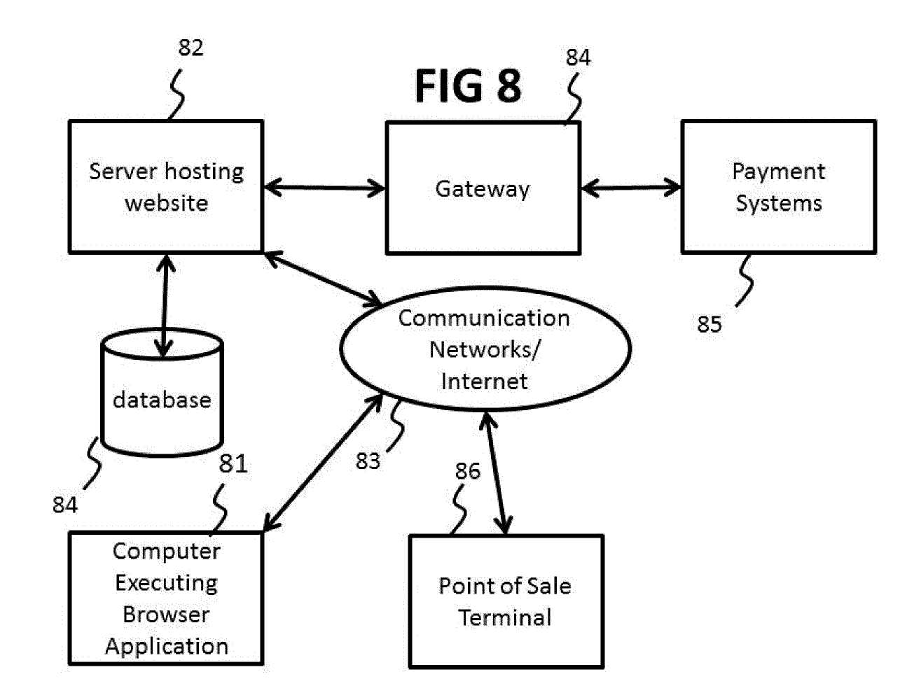

FIG. 8 depicts an exemplary embodiment of an apparatus for enabling a user to pay with a preregistered credit card, payment card or bank account by merely using his telephone number. First, the user navigates a browser executing on his computer 81 to a predetermined website being hosted by a server 82, such as www.pmoney.com. The browser may be Internet Explorer, Mozilla Firefox, Chome or any other traditional browser. The user's computer 81 may be a desktop, laptop, smart phone or handheld computing device. The user's computer 81 may connect to the server 82 via the Internet or any other communications network 83. Communications networks/Internet 83 could be multiple public or private networks, but are shown as one for simplicity purposes.

The browser displays a screen on the user's computer 81 enabling the user to create a user profile (e.g., name, address, telephone number, social security number, password, user ID, PIN, and mother's maiden name or other secondary authentication information). Next, the user enters his or her credit card, payment card, charge card or bank account information. This is the traditional information such as credit card number, expiration date, billing address, security code and other related information. For a bank account, this will include the routing number and the bank account number, as well as the bank name, address, contact information, user account information, etc. Once these accounts are entered, the, the user can then link these various credit card accounts, payment card accounts or bank accounts to his profile so that when the user wishes to conduct a transaction with a merchant or other person, for example, the user can use his or her telephone number as a payment mechanism, which then allows the user to select one of the linked credit card or bank accounts as the actual payment mechanism.

Once the linked accounts are verified by the server 82, they are stored in a database 84 in a record associated with the user, which when retrieved has available all of the user's profile information and linked accounts information necessary to conduct a transaction with the linked accounts. The database 84 is a standard SQL type database. For example, if the user linked a credit card account, such as VISA or Mastercard, the user previously entered the credit card number, the expiration date, the billing address information, and the security code. This information is then available for the server 82 to use when conducting a transaction with the credit card system 85 via the gateway 84 that communicates with the various payment systems.

When the POS terminal 86 wishes to conduct a transaction with the user designated payment mechanism 85, the transaction information is sent over the communication network 83 to the server 86, which retrieves the user's payment information and creates the necessary transactional details and sends these transactional details to the payment system 85 via the gateway 84 in the traditional manner. Payment systems 85 could be one or more different payment systems but are shown as one for simplicity purposes.

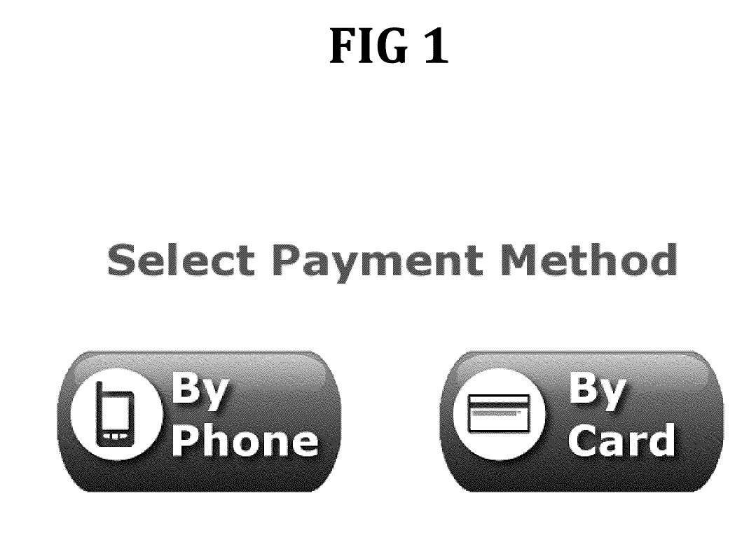

FIGS. 1-7 depict the transaction flow of one exemplary embodiment of the present invention called “PMoney”. The steps involved for the customer at the point of sale terminal include: (1) select payment method; (2) enter phone number; (3) enter authentication code; (4) approve transaction amount; (5) select payment type; (6) view transaction processing screen; and (7) view transaction processing response.

Prior to the transaction in FIGS. 1-7, the user navigated to a predetermined website (e.g., www.pmoney.com) and created a user profile

Step 1

The screen as displayed in FIG. 1 is the first option provided to user in the exemplary embodiment of the transaction flow. At this point, the user is provided with an option of selecting a method of payment either by using PMoney or by using his/her payment card. In this example, the user selects “By Phone” from the list of available options.

Step 2

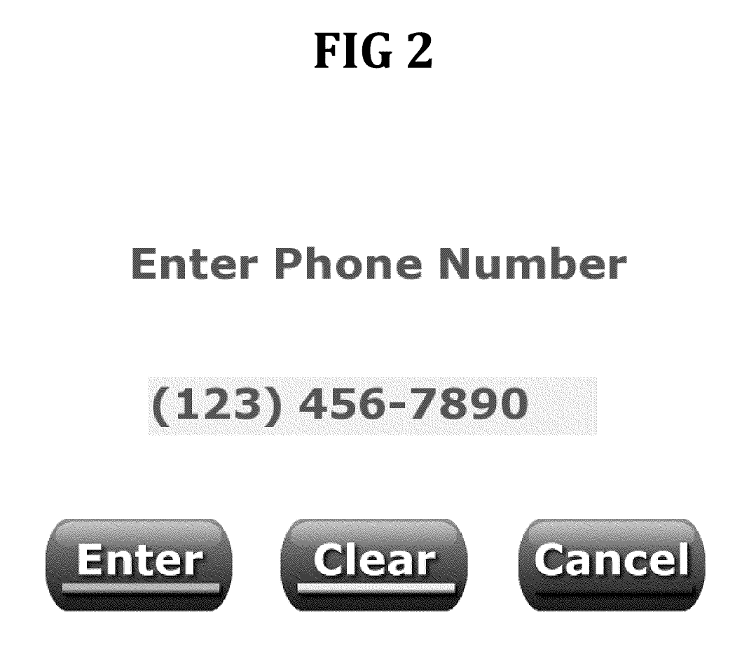

In the screen as displayed in FIG. 2, the user enters the phone number he previously registered at PMoney website. At this point, the available options to users on the screen are:

Enter—Proceed with the entered Phone Number

Clear—Clear the entered number and start over again.

Cancel—Cancel the current transaction.

In this continuing example, the user enters his registered phone number through keypad on terminal and selects “Enter”.

Step 3

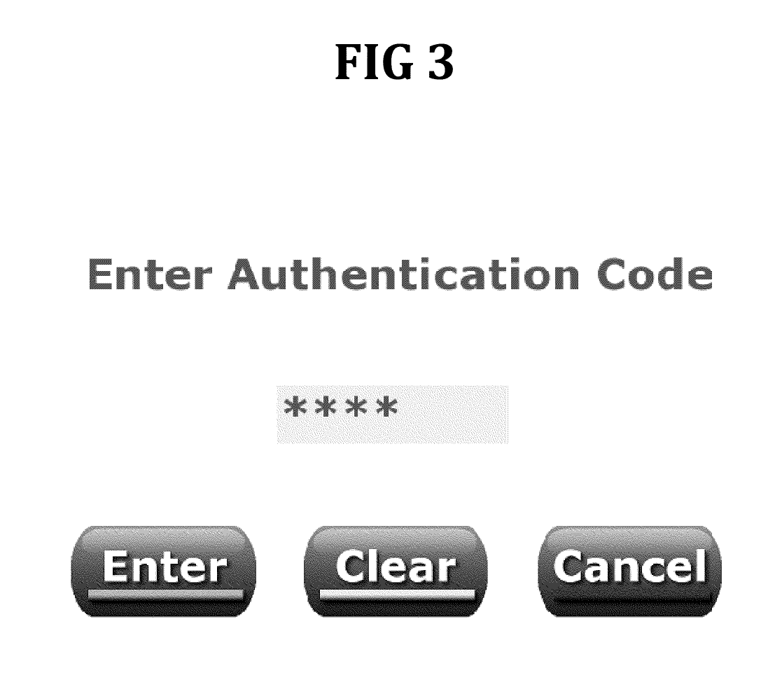

In the screen as displayed in FIG. 3, the user enters his authentication code registered along with phone number at PMoney website. At this point, the available options to users on the screen are:

Enter—Proceed with the entered Authentication code

Clear—Clear the entered code and start over again.

Cancel—Cancel the current transaction.

In the continuing example, the user enters his registered authentication code through keypad on terminal and selects “Enter”.

Step 4

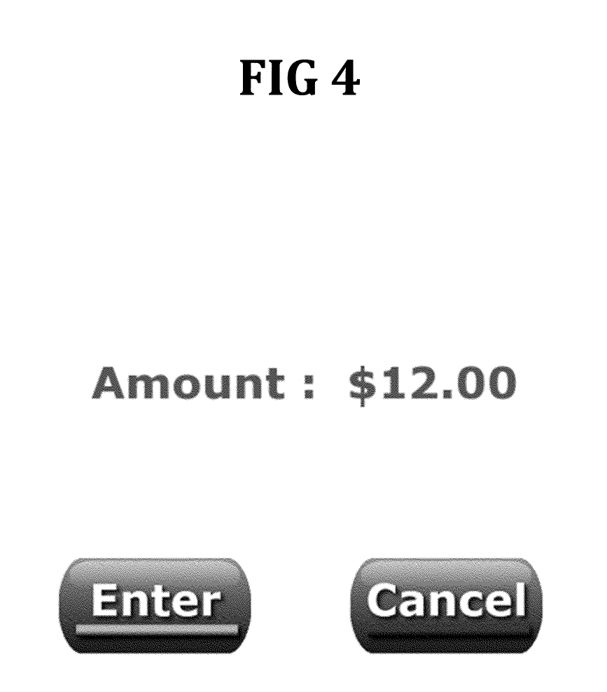

In the screen as displayed in FIG. 4, the user confirms the amount for which he/she is willing to pay. The available options to user are:

Enter—Confirm the said amount and proceed with transaction.

Cancel—Cancel the current transaction.

In this continuing example, the user selects “Enter” from provided options.

Step 5

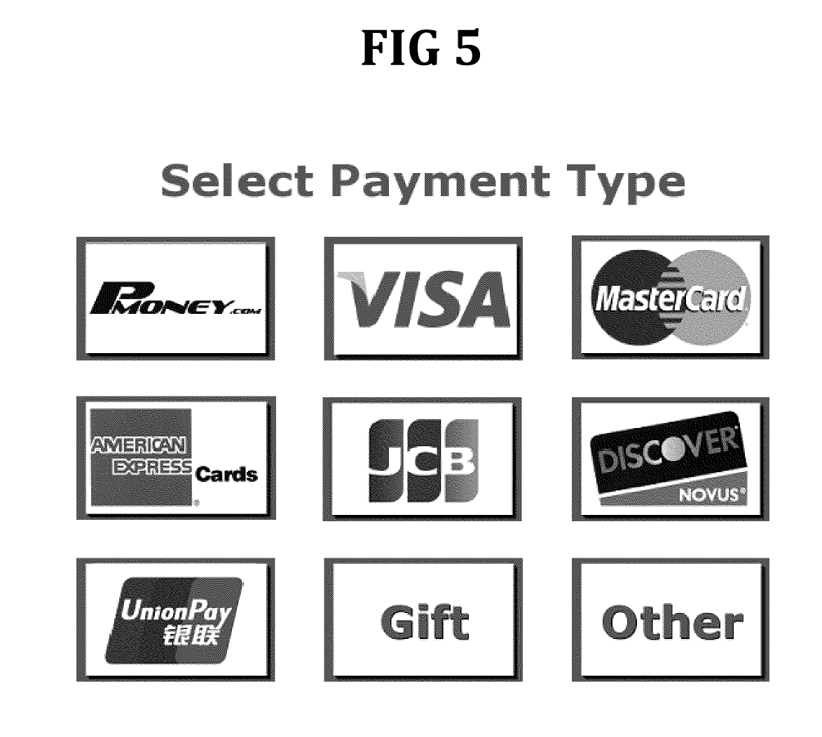

In the screen as displayed in FIG. 5, the user selects from provided payment types. By now, the point of sale terminal has communicated via a network with the database coupled to the server associated with the website, on which the user registered. The database has returned the available payment mechanisms associated with the user's account to the point of sale terminal, which are then displayed to the user as in the screen shown in FIG. 5. For example, if a user wants to make payment through a VISA card registered at PMoney website the user can select the “VISA” option. The transaction amount will then be processed using the respective payment mechanism in the traditional manner by the point of sale terminal using the registered user's designated account.

In this continuing example, the user selects “PMoney.com” from provided options.

Step 6

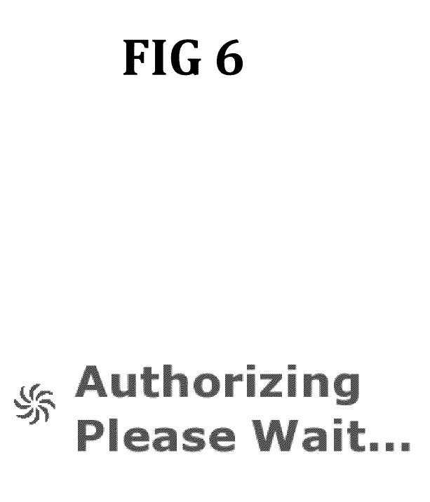

Once the payment type is selected transaction processing start and the screen as displayed in FIG. 6 is seen. User credentials and options selected previously are processed at payment gateway. During this screen, the user needs to take no action.

Step 7

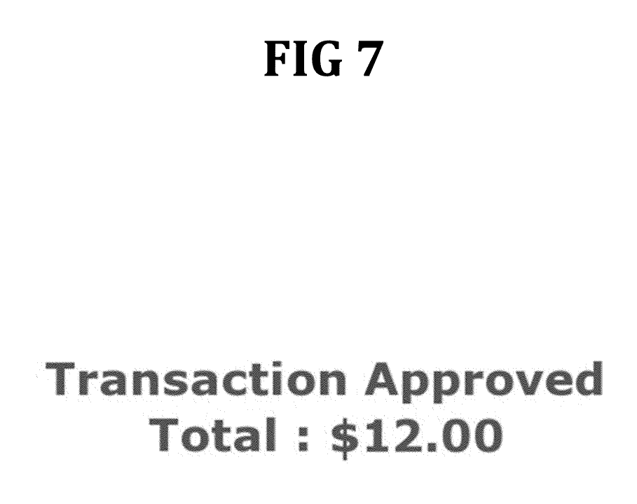

Once the processing has taken place and the point of sale terminal has received a response from the payment gateway, the transaction approved/declined screen as seen in FIG. 7 is displayed for certain period of time.

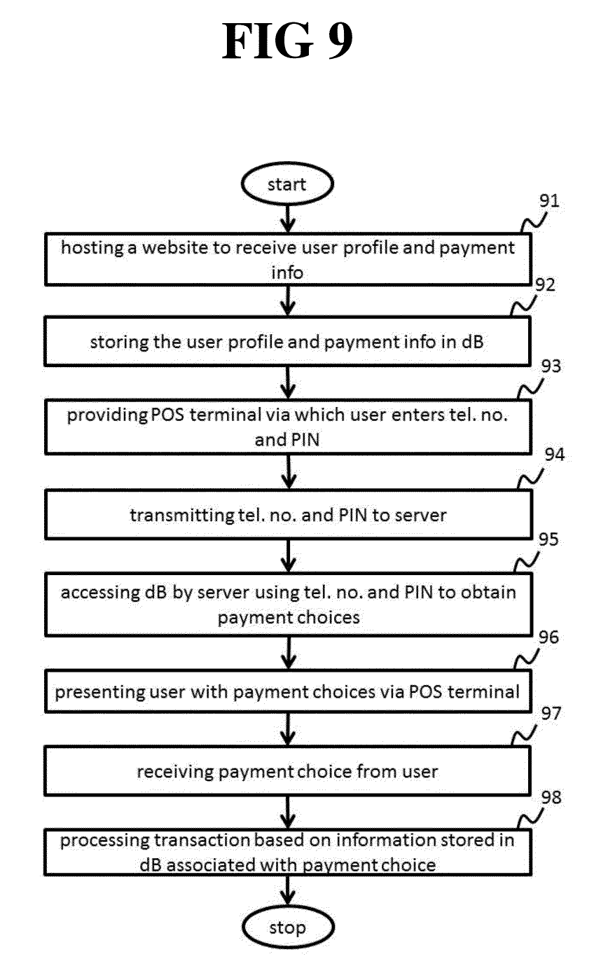

Turning to FIG. 9, shown therein is a computer implemented method for paying for goods and services. In step 91, the method begins by hosting a website via which a user can register and enter user profile information and payment information regarding one or more payment accounts to be associated with the user profile.

In step 92, the method stores the user profile and said payment information in a database.

In step 93, a point of sale terminal is provided via which a user may enter a telephone number and a personal identification number as at least one option for paying electronically.

In step 94, the telephone number and personal identification number are transmitted to a server.

In step 95, the database is accessed by the server using the received telephone number and received personal identification number to obtain one or more choices for payment based on the payment information associated with the received telephone number and received personal identification number.

In step 96, the user is presented with the one or more choices for payment via the point of sale terminal.

In step 97, an indication is received from the user as to which one of the one or more choices for payment the user wishes to use for this transaction.

In step 98, an electronic payment transaction is processed using the indicated one of the one or more choices for payment based on the payment information stored in the database and associated with the indicated one of the one or more payment choices.

Various non-transitory computer readable media may be used to store various portions of the above described methods.

Although various embodiments are specifically illustrated and described herein, it will be appreciated that modifications and variations of the invention are covered by the above teachings and within the purview of the appended claims without departing from the spirit and intended scope of the invention. For example, while several of the embodiments depict the use of a ten digit telephone number, other numbers of digits will suffice, such as for example, seven or eleven. Moreover, while a four digit PIN is described herein, other numbers of digits of a PIN will also suffice. Furthermore, these examples should not be interpreted to limit the modifications and variations of the invention covered by the claims but are merely illustrative of possible variations.

1. A computer implemented method for paying for goods and services comprising:
hosting a website via which a user registers and enters user profile information and payment information regarding one or more payment accounts to be associated with the user profile;
storing the user profile and said payment information in a database;
providing a point of sale terminal via which the user enters a telephone number and a personal identification number as at least one option for paying for the goods or services electronically, wherein said telephone number includes a non-mobile telephone number;
transmitting the telephone number and personal identification number to a server;
accessing the database by the server using the received telephone number and received personal identification number to obtain one or more choices for payment based on the payment information regarding one or more payment accounts associated with the received telephone number and received personal identification number entered by the user on the website;
presenting the user with said one or more choices for payment via the point of sale terminal based on the payment information regarding one or more payment accounts entered by the user on the website;
receiving an indication from the user as to which one of said one or more choices for payment the user wishes to use; and
processing an electronic payment transaction using the indicated one of the one or more choices for payment based on the payment information regarding one or more payment accounts stored in the database and associated with the indicated one of the one or more payment choices.

2. An apparatus for enabling a user to pay for goods and services comprising:
one or more servers to host a website that receives user profile information and payment information from a user, said payment information regarding one or more payment accounts associated with the user profile;
a database to store the user profile and said payment information;
a point of sale terminal to accept from the user a telephone number and a personal identification number, said point of sale terminal to transmit the telephone number and personal identification number to the one or more servers, wherein said telephone number includes a non-mobile telephone number;
said one or more servers to use the received telephone number and received personal identification number to access the database to obtain one or more choices for payment based on the payment information associated with the received telephone number and received personal identification number;
said point of sale terminal to present the user with said one or more choices for payment;
said point of sale terminal to receive an indication from the user as to which one of said one or more choices for payment the user wishes to use; and
said one or more servers to process an electronic payment transaction using the indicated one of the one or more choices for payment based on the payment information stored in the database and associated with the indicated one of the one or more payment choices.

3. A non-transitory computer readable media having a plurality of instructions encoded thereon comprising:
hosting a website via which a user enters and registers user profile information and payment information regarding one or more payment accounts to be associated with the user profile;
storing the user profile and said payment information in a database;
providing a point of sale terminal via which a user enters a telephone number and a personal identification number as at least one option for paying electronically for goods or services, wherein said telephone number includes a non-mobile telephone number;
transmitting the telephone number and personal identification number to a central server;
accessing the database by the central server using the received telephone number and received personal identification number to obtain one or more choices for payment based on the payment information regarding one or more payment accounts associated with the received telephone number and received personal identification number;
presenting the user with said one or more choices for payment via the point of sale terminal;
receiving an indication from the user as to which one of said one or more choices for payment the user wishes to use; and
processing an electronic payment transaction using the indicated one of the one or more choices for payment based on the payment information regarding one or more payment accounts stored in the database and associated with the indicated one of the one or more payment choices.
